(19) United States
(12) Patent Application Publication
(10) Pub. No.: US 2003/0164459 A1
(43) Pub. Date: Sep. 4, 2003

(54) Device for positioning a tumour patient with a tumour in the head or neck region in a heavy-ion theraphy chamber

(76) Inventors: Dieter Schardt, Darmstadt (DE); Peter Heeg, Darmstadt (DE)

Correspondence Address: Ronald R Santucci, Frommer Lawrence & Haug, 745 Fifth Avenue, New York, NY, 10151, US

(21) Appl. No.: 10/296,011

(22) PCT Filed: May 23, 2001
(86) PCT No.: PCT/EP01/05934

(30) Foreign Application Priority Data
May 26, 2000 (DE) 100 25 913.8

(51) Int. Cl. G21G 5/00

(52) U.S. Cl. 250/492.3

(57) ABSTRACT

The invention relates to a device for positioning a tumour patient (1) having a tumour (2) in the head/neck region (3) in a heavy ion therapy room (5) with respect to a heavy ion beam (6) from an unchangeable direction (C) that is fixed by spatial coordinates, the heavy ion beam (6) being guided by means of two rapid deflection magnets (7) over the tumour cross-section orthogonally in the horizontal and vertical direction and the depth of penetration of the ion beam being determinable by varying the heavy ion energy and the amount of radiation by means of adjustment of the heavy ion dose in an irradiation plan and being monitorable by a PET camera installed in the radiation room, wherein the device, as an alternative to a patient couch, fixes the patient (1) in the seated position and has mechanisms that, by the degrees of freedom of movement of the device (8), keeps the tumour (2) of the patient (3) in the isocentre (9) of the ion beam (6).

The present invention relates to a device for positioning, in a heavy ion therapy room, a tumour patient having a tumour in the head/neck region.

Known heavy ion therapy rooms are equipped with patient couches on which the patient is fixed in position in the head/neck region by means of an irradiation mask and the patient couch is aligned in relation to a horizontal beam tube for the heavy ion therapy beam. Such known devices allow irradiation or bombardment directions in a frontal plane of the patient's head which, in limited cases, allows satisfactory dose distributions. For that purpose, the ion beam is guided by means of two rapidly operating deflection magnets over the cross-section of the tumour in the horizontal and vertical direction transversely to the ion beam, the depth of penetration of the heavy ion beam being determined by varying the heavy ion beam energy and the amount of radiation by means of adjustment of the heavy ion dose in an irradiation plan as a function of the size and spatial extent of the tumour tissue. During irradiation, the irradiation procedure is monitored by a PET camera installed in the radiation room.

As a result, however, of the frequent configuration of tumours, which are directly adjacent to high-risk organs, such as the brain stem, the optical nerve, the chiasma or the eyes, not all the high-risk organs of the head/neck region of a patient can always be adequately protected with only the one degree of freedom rendered possible by rotation of the patient couch about a vertical axis. It is therefore not possible for every radiation plan, in which the loading of the individual high-risk organs would still be tolerable according to a dosage volume histogram, to be applied in practice, since in such cases there is no absolutely reliable guarantee of risk-free irradiation angles or bombardment angles for the ion beam in the head/neck region.

The use of the heavy ion beam is also limited because ions had to stop directly before a high-risk organ after passing through very inhomogeneous material. Slightly incorrect lateral positioning would result in considerable change in the field of action and consequently in an erroneous dose in the high-risk organ. With the limited possibilities of a patient couch there are therefore only limited possibilities for treating tumours in the head/neck region.

The problem of the invention is to provide a device that renders possible, as an alternative to a patient couch, at least one further degree of freedom for the alignment of the patient's head.

Known solutions include the construction of an ion-beam gantry into which a patient couch is inserted and the ion beam is guided in a cylindrical cradle so that it can irradiate the patient from any spatial direction. Such cost-intensive solutions are not suitable for a heavy ion therapy room, however, when the heavy ion beam radiates horizontally only from an unchangeable spatial direction with respect to the spatial coordinates. Also, the slight excursion of the ion beam during rapid scanning of a tumour cross-section cannot solve that problem for a heavy ion therapy room equipped in such a manner. In addition, the spatial dimensions of a gantry that extends over several floors of a building are unsuitable for limited heavy ion therapy rooms.

The problem is solved by the independent claims. Preferred further developments of the invention are disclosed in the dependent claims.

According to the invention, the device for positioning a tumour patient has, as an alternative to a patient couch, a device that fixes the patient in the seated position. The device has mechanisms that, by the degrees of freedom of movement of the device, keep the tumour of the patient in the isocentre of the heavy ion beam. Keeping the tumour in the isocentre of the heavy ion beam has the advantage that all available degrees of freedom offered by a seated position of the patient have an effect solely on the angle at which the tumour tissue can be bombarded but not on the fixing of the patient in the three spatial coordinates X, Y and Z, that is to say, the origin of the Cartesian coordinates system is simultaneously the centre of the tumour and the point of intersection with the ion beam and, in spite of the alteration and adjustment of the angle, that configuration is retained by way of the additional degrees of freedom of rotational movement of the device for a patient in the seated position.

In a preferred embodiment of the device, the device has, as further degree of freedom of movement, a tilting movement about at least one horizontal axis that intersects the heavy ion beam in the isocentre. Such a tilting movement is not provided for conventional patient couches so that, with that tilting movement of the device, it is possible for patients that could not be treated hitherto to be treated.

In a further embodiment of the invention, the device has a degree of freedom of rotational movement about a vertical axis that intersects the heavy ion beam in the isocentre. With that degree of freedom of movement of the device, the device is adapted to the possibilities of a patient couch that has only that one degree of freedom of rotational movement, with the result that treatment plans provided for a patient couch can be recalculated or converted in simple manner into treatment plans for the new device.

In a further preferred embodiment of the invention, the device has the degrees of freedom of movement of the three translations in the stereotactic coordinates X, Y and Z. The spatial arrangement of the drives for the different degrees of freedom of the different embodiments of the invention are so coordinated with one another that the drives for the translational movements are arranged at positions above the drives for the rotational movements. Only that positional arrangement enables the device to exploit the degrees of freedom of rotation and simultaneously retain the tumour position in the isocentre. As a result, in an advantageous manner also the adjustment of the device with respect to the isocentre is facilitated by first of all setting the target coordinates for the irradiation of a tumour in the head/neck region by means of the three translational movements and then executing an isocentric rotation and/or an isocentric tilting of the device.

For that purpose, in a further preferred embodiment of the invention, the drives for the rotational movements about a horizontal and a vertical axis with their points of intersection in the isocentre of the heavy ion beam are arranged below the seat position of a patient and spatially below the translational drives.

In a further preferred embodiment of the invention, for the rotation or tilting about a horizontal axis, the device has curved guides below the seat area and/or couch area. The couch area only has any relevance when, in a preferred embodiment of the invention, the seat position of the patient can be adjusted to a couch position. This, however, involves a high level of technical complexity if the horizontal and vertical rotational movements are simultaneously to be retained in the isocentre for the head/neck region of a patient.

In a preferred embodiment of the invention, all adjustable degrees of freedom of movement can be set by electric motors. Such electromotor drives have the advantage that both the translational adjustments and the rotational adjustments can be carried out with the utmost precision, with the result that an accuracy of less than 0.5 mm can be achieved in the translational direction and an angle departure of less than 0.1° can be set in the rotational direction.

In a further preferred embodiment of the device, the device has as drive units, for displacement in the X, Y and Z directions, that is the three translations of the stereotactic coordinates, and for the rotation about a horizontal and a vertical axis, stepper motors having position-measuring means, limit switches and electronic control modules. An advantage of stepper motors is that they can be digitally controlled by way of electronic control modules and the translational and rotational movements of the device can be carried out in steps of predetermined accuracy. The limit switches provide additional security against extreme angles and extreme lateral departures from the set parameters, and against incorrect interpretations of the irradiation plan by electronic control modules.

In a preferred further development of the invention, the drives for translational displacements of the device are arranged outside an immediate seat position of the device. This has the advantage that the seat position can be arranged as low as possible, for example when the translational drive for the height adjustment in the Z direction is arranged in the region of the seat back.

In particular, the device is preferably provided with an automatic emergency disconnector switch so that, in the event of obvious incorrect interpretations of the treatment position, a rapid and automatic intervention and correction is rendered possible. For that purpose the device is controllable by means of a control program that provides collision protection and cooperates with a movement-limiting monitoring device.

In a further preferred embodiment of the invention, a translational displacement of the device in the direction of the heavy ion beam is provided on travel rails, a long path of travel of the device from a park position into a patient treatment position being provided and a device for fine adjustment, which is independent of the travel rails, being effective in the patient treatment position. This has the advantage that the device according to the invention, which fixes the patient in the seated position, is displaceable in a short period of time into a park position that does not impede the insertion of a patient couch. In a further preferred embodiment of the invention, the positioning accuracy of the device in all translationally adjustable degrees of freedom is less than or equal to 0.5 mm, preferably less than or equal to 0.1 mm. This high level of positioning accuracy ensures that the device can be set exactly in the isocentre for the heavy ion beam and positional deviations, and thus incorrect irradiations, are avoided. For that reason the device is adjustable in the isocentre with an accuracy of from ±1 to ±0.5 mm. To that end the device is preferably connected in a cooperating manner with a position-monitoring means in the heavy ion treatment room, so that the tumour position continues to be monitored in the isocentre. Such a position-monitoring means is preferably an X-ray camera. The X-ray camera measures exactly, before and after treatment, the set translational positions, and thereby ensures that the device operates precisely also between the treatments.

In a further preferred embodiment of the invention, the device has a computer that recalculates, as desired, the target coordinates and treatment settings for positioning a patient in the lying and/or seated position. By means of such a computer it is advantageously possible to combine the two irradiation positions consisting of a lying and a seated position and perform the irradiation at various irradiation angles, so that healthy tissue lying above the tumour is given optimum protection.

To monitor the irradiation of a patient, the camera heads of the PET camera are preferably rotatably mounted about the heavy ion beam axis. The rotatable mounting makes it possible to monitor both the irradiation on a patient couch and the irradiation on a device in which the patient is in the seated position using one and the same PET camera.

Thus, in a preferred embodiment of the device, a combined irradiation of a patient in the seated and lying position is possible in association with a patient couch and the device according to the invention.

In order to match the body size of the patient to the isocentre of the heavy ion beam, the device has a sufficiently adjustable height setting in the Z direction. For that purpose, the height-adjusting means has a travel range of from ±100 to ±500 mm, preferably from ±200 to ±300 mm. The height-adjusting means can be operated at a travel speed of from 1 to 15 mm/s, preferably from 2 to 5 mm/s, the high travel speeds being performed without the patient while the slower travel speeds are performed with the patient in position.

In the patient treatment position, in the horizontal translational displacement in the X and Y directions the drive device preferably has a travel range of from 100 to 200 mm, preferably from 120 to 150 mm, with a travel speed of from 5 to 200 mm/s, preferably from 8 to 10 mm/s.

The rotation about a horizontal axis is preferably limited to a preferred tilting movement which operates with a tilting range of ±30°, preferably ±20°, the speed of the tilting movement being from 0.5 to 1 /s, preferably from 0.6 to 0.8°/s. In that case, too, when a patient is fixed in the seated position, the lower tilting movement speeds are used.

The range of rotation about a vertical axis is not limited and may be a complete circle from 0 to 360°. When the patient is in the seated position for the heavy ion treatment of the patient in the head/neck region, the rotational movement can advantageously be carried out in less space than in the case of a patient couch. For such a rotation, in a preferred embodiment of the invention a speed of rotation about the vertical axis of from 1 to 10°/s, preferably from 3 to 6°/s, is preferred.

A preferred method of treating a tumour of a patient in a head and/or neck region in a heavy ion treatment room having a heavy ion beam direction that is fixed with respect to the spatial coordinates comprises, when the device according to the invention is used to position a tumour patient, the following steps:

calculation of an optimum bombardment angle for the heavy ion beam (5) through healthy tissue in the direction of the tumour giving consideration to high-risk areas;

movement of the patient chair, in which the patient is fixed in position, from a park position into a treatment position;

setting of the stereotactic target point coordinates by three translations in the X, Y and Z directions so that the tumour is positioned in the isocentre;

setting of the optimum bombardment angle by rotational movement in the isocentre about a horizontal and/or vertical axis;

measured irradiation of the tumour tissue, with minimal involvement of the surrounding tissue, at the calculated optimum bombardment angle.

In a preferred execution of the method, after reaching the treatment position first of all the translational adjustments in the X, Y and Z directions are made until the tumour is arranged in the isocentre of the ion beam, and then the rotation about a horizontal axis is carried out, which is adjusted by means of the curved guides below the seat area of the device, and finally the rotational adjustment about a vertical axis is carried out. Since, according to the invention, the drives for the translational movements for alignment of the tumour in the isocentre of the ion beam are arranged spatially above the curved guide for the tilting movement and above the drive for the rotational movement, and the axes of the rotational movement advantageously intersect in the isocentre, advantageously no translational displacement of the tumour is associated with the rotational movements.

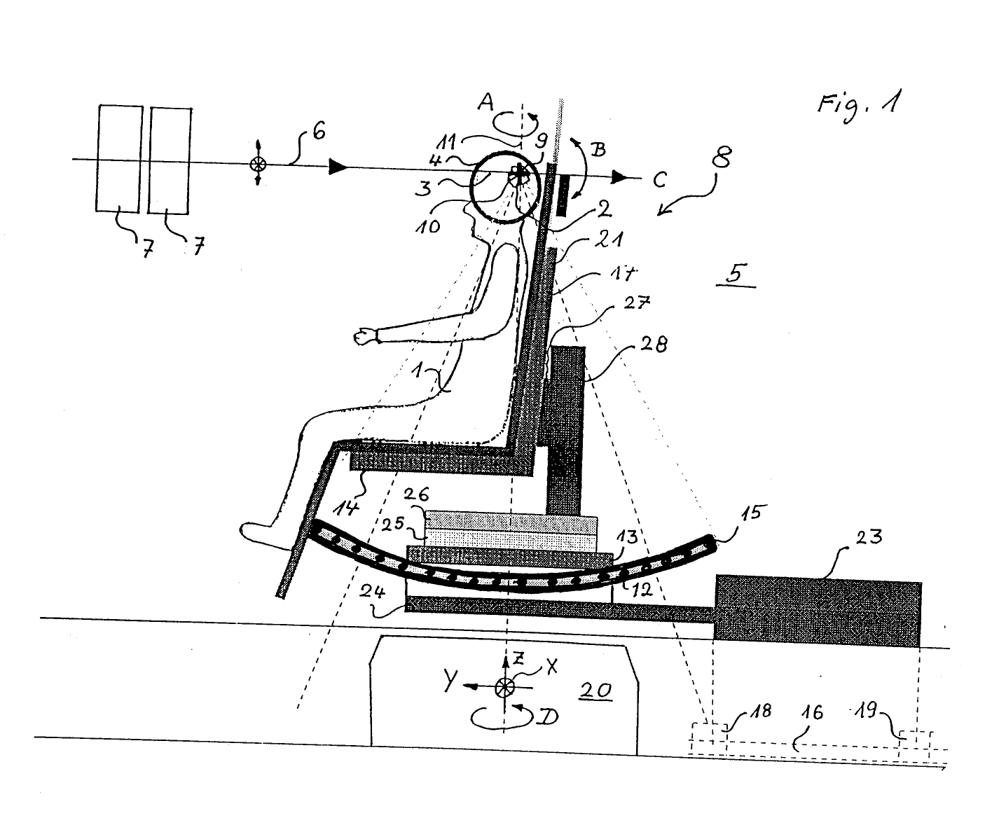

Further features, advantages and properties of the device are now described in detail by way of an embodiment example with reference to FIG. 1.

FIG. 1 shows a device 8 for positioning a tumour patient 1 having a tumour 2 in the head/neck region 3 in a heavy ion therapy room 5 relative to a heavy ion beam 6 from an unalterable direction C that has been fixed by spatial coordinates. The heavy ion beam 6 can be guided by means of rapid deflection magnets 7 over the tumour cross-section in the horizontal and vertical direction orthogonally to the beam. The depth of penetration of the heavy ion beam 6 can be determined by varying the heavy ion energy and the amount of radiation by means of adjustment of the heavy ion dose in the radiation room.

The heavy ions used are usually carbon ions, but it is also possible to carry out the procedure in such a treatment room using light ions, such as protons.

The irradiation of the patient is monitored by means of a PET camera, which is not shown here. In this embodiment of the invention, the rotational movement A about a vertical axis 11 and the rotational movement B about a horizontal axis 10 intersect in the isocentre 9 of the heavy ion beam. On this device for positioning a tumour patient, the patient is fixed in the seated position.

There is located transversely to the device in the drawing, in a park position which is not shown, a patient couch normally used for such radiation rooms. Such a patient couch for the treatment of tumours in the head and neck region 3 of a patient demands a substantially larger radius of rotation compared with the device in the drawing, since the patient has to be rotated on a patient couch about the isocentre with the tumour in the head or neck region. In this embodiment, the drive means 20 for a patient couch is arranged directly below the patient chair 21.

The translational directions X, Y and Z are also provided in the drive unit 20 of the patient couch and, with a direction of rotational movement D of the patient couch about a vertical axis 11, an irradiation angle or bombardment angle of the ion beam 6 can be adjusted in limited manner in the frontal plane. In order to be able to use the PET camera (not shown) both when the patient chair 21 and when the patient couch (not shown) is used, the camera heads are rotatably mounted about the beam axis C of the heavy ion beam 6. In order to monitor the irradiation procedure, in the lying operation the camera heads are aligned vertically and, when operating with the patient chair, they are set horizontally.

The patient chair 21 is arranged on a cantilever platform 24, which is held by a device 23. The device 23 is movable by means of underfloor guides 18 and 19 on underfloor travel rails 16. The cantilever platform 24 can be moved by means of the device 23 into a park position when a patient is to be treated on a patient couch and, for the treatment, is moved into the treatment position illustrated in FIG. 1, the platform 24 being arranged above the drive unit 20 of the couch. The degrees of freedom for adjustment of the patient chair are, from top to bottom, spatially arranged in the following order:

1. tilting by means of the drive unit 12

2. rotation by means of the drive unit 13

3. translation in the horizontal directions X and Y with the drive units 25 for the X direction and 26 for the Y direction.

4. a vertical translation, the drive unit 27 of which is secured in the Z direction to a column 28 that is arranged vertically on the translational drives 25 and 26.

The vertical translation serves to match the body size of the patient. For that purpose the drive unit 27 for the vertical translation is connected to the patient chair back 17. The essential technical data of this embodiment of the invention are given in Table 1.

TABLE 1

| | | |
|---|---|---|
| Horizontal translation | Travel range: | ±120 mm |
| | Speed: | 8.3 mm/s |
| Vertical translation | Travel range: | ±250 mm |
| | Speed: | 2 mm/s |
| | Speed without patient | also 4 mm/s |
| Rotation: | Range of rotation: | 360° |
| | Speed: | 3.3 °/s |
| Tilting: | Tilting range: | ±19° |
| | Speed: | 0.75 °/s |
| Accuracies: | Isocentre accuracy: | ±0.5 mm |
| | Inherent positioning accuracy: | ±0.5 mm |
| Weight: | Weight of positioning unit: | c. 350 kp |

The mechanics for the two rotations about a vertical axis 11 and a horizontal axis 10 and for the horizontal translations are located below the seat area and in this embodiment claim a height of less than 35 cm. The device is tilted about a spatially fixed horizontal axis 10 transversely to the beam direction C. The patient chair 21 is at the same time moved in the curved guides 15. Rotation and tilting are concentric, and the point of intersection of the axes 11 and 10 can be spatially fixed and, by way of the translational adjustments in the X, Y and Z directions, positioned in the isocentre. With the travel range of the translations, any target point of the patient head can be set in the isocentre. The travel range of the vertical translation, which is located behind the chair back, additionally also meets the requirements of compensating for the patient size. All degrees of freedom of this device in the embodiment of FIG. 1 are controlled by electric motors.

A tolerance limit of ±0.5 mm is achieved both for the inherent positioning accuracy and for the position of the isocentre in space.

An important feature of the treatment chair is that a positioning technique analogous to that already tried in the case of patient couches is used. To that end, the axis of rotation is set at right angles and the angle of rotation is set at 0°, so that the patient looks in the direction of the beam. The stereotactic coordinates are then adjusted with the aid of a targeting apparatus by three translations in the X, Y and Z directions, and finally the angles of rotation and the tilting angle are set in order to determine the bombardment direction of the ion beam.

The advantage of that procedure is that it proceeds analogously to the positioning of a patient couch and there are therefore no increased difficulties in the irradiation planning. Thus, the changes for the irradiation planning remain manageable, since no angle-dependent translations are required. An important difference of the device according to the invention, however, is the possibility of being able to adjust at least two angles. In a planning program, on account of the horizontal beam tube of the ion beam, during irradiation using the patient couch a gantry angle of 90° is expected, and within a frontal plane the direction of irradiation or bombardment direction can be adjusted by the table angle.

Use of the patient chair without the use of tilting corresponds to that planning program for the patient couch, so that the directions of irradiation and bombardment-angles can be executed only within the transverse plane. When the tilting angle is used, however, there is no association of the two possible patient chair angles with the adjustment angle of a patient couch. The chair angles to be adjusted can be calculated by means of coordinate conversion from the planning angles. For planning practice, a decisive advantage associated with this device for positioning a patient on a patient chair is that both plans for a patient couch and for a treatment chair can be calculated using the same program.

Thus, in principle, the prerequisites for irradiation plans with mixed zones (couch and chair) are provided with the use, in addition, of the device according to the invention. This increases the planning freedom for the treatment of tumour patients having tumours in the head and neck region. The patient chair according to the invention is therefore an extension of conventional medical irradiation devices and represents an improvement in the possibilities for treating tumours in the head and neck region of a patient.

In view of the fact that the irradiation point in the radiation room is at a predetermined low height above the floor, conventional patient chairs are unsuitable especially since, for the patient couch, the drive mechanics and drive unit 20 are already arranged in the false floor below the irradiation point. The arrangement of the whole of the patient chair 21 on the cantilever platform, which projects over the drive unit 20 of the couch, gives the particular advantage that the positioning device can be moved back and forth on sliding rails between treatment position and park position with good reproducibility.

### List of reference symbols

1 tumour patient

2 tumour

3 head/neck region

4 irradiation mask

5 heavy ion therapy room

6 heavy ion beam

C heavy ion beam direction

7 deflection magnets

8 device for positioning a patient

9 isocentre

B tilting movement

10 horizontal axis

A rotational movement about a vertical axis

11 vertical axis

12 drive for rotational movement about the horizontal axis

13 drives for rotational movement about the vertical axis

14 seat position

15 curved guides

16 travel rail

17 seat back

18,19 underfloor guides

20 drive unit for patient couch

21 patient chair

22 surrounding tissue

D direction of rotational movement of the patient couch

23 device for movement of the patient chair

24 platform

25 drive unit for the X direction

26 drive unit for the Y direction

27 drive unit for the height adjustment

28 column

1. Device for positioning a tumour patient (1) having a tumour (2) in the head/neck region (3) fixed by means of an irradiation mask (4) in a heavy ion therapy room (5) with respect to a heavy ion beam (6) from an unchangeable direction (C) that is fixed by spatial coordinates, the heavy ion beam (6) being guided by means of two rapid deflection magnets (7) over the tumour cross-section in the horizontal and vertical direction orthogonally to the beam direction (C), and the depth of penetration of the heavy ion beam (6) being determinable by varying the heavy ion energy and the amount of radiation by means of adjustment of the heavy ion dose in an irradiation plan and being monitorable by a PET camera installed in the radiation room, wherein the device has a patient chair (21) on which the patient (1) can be fixed in the seated position and the device has drives for translational movements (25, 26, 27) in order to align the tumour (2) in the isocentre (9), and wherein the patient chair (21), including drives for translational movements (25, 26, 27), can be rotated by a device (12, 15) for rotation about a horizontal axis (10) and/or by a device (13) for rotation about a vertical axis (11), the axes (10,11) intersecting with the heavy ion beam (6) in the isocentre (9),
characterised in that, during the alignment of the tumour (2) in the isocentre (9), the drives for translational movements (25, 26, 27) shift the patient chair (21), including the fixed patient (2), in the X, Y and Z directions.

2. Device according to claim 1, characterised in that the drives (12, 13) for rotational movements about a horizontal and a vertical axis (10, 11) with their points of intersection in the isocentre (9) of the heavy ion beam (5) are arranged below the seat position (14) of the patient (1).

3. Device according to claim 1 or 2, characterised in that, for the rotation or tilting about a horizontal axis (10), the device (8) has curved guides (15) below the seat area and/or couch area.

4. Device according to any one of the preceding claims, characterised in that all adjustable degrees of freedom of movement can be set by electric motors.

5. Device according to any one of the preceding claims, characterised in that the arrangement of the degrees of freedom of movement of the device (8) bring about isocentric tilting and rotation in the order, from bottom to top, tilting, rotation, translation (X, Y, Z).

6. Device according to any one of the preceding claims, characterised in that the device (8) has, as drive units (12, 13) for displacement in the X, Y and Z directions, the three translations of the stereotactic coordinates, and for rotation about a horizontal and a vertical axis (10, 11), stepper motors having position-measuring means, limit switches and electronic control modules.

7. Device according to any one of the preceding claims, characterised in that, when located in the park position, the device permits irradiation on a patient couch that is in the irradiation position.

8. Device according to any one of the preceding claims, characterised in that the drives for translational displacements of the device (8) are arranged outside an immediate seat position (14) of the device (8).

9. Device according to any one of the preceding claims, characterised in that the device (8) is provided with an automatic emergency disconnector switch.

10. Device according to any one of the preceding claims, characterised in that the device (8) is controllable by means of a program that provides collison protection and cooperates with a movement-limiting/monitoring means.

11. Device according to any one of the preceding claims, characterised in that a translational displacement of the device (8) is provided in the direction of the heavy ion beam (6) on travel rails (16), a long path of travel of the device (8) from a park position into a patient treatment position being provided, and a device for fine adjustment in the patient treatment position being provided.

12. Device according to any one of the preceding claims, characterised in that the positioning accuracy of the device (8) in all translationally adjustable degrees of freedom (X, Y, Z) is less than or equal to 0.5 mm.

13. Device according to any one of the preceding claims, characterised in that the device (8) can be set in the isocentre (9) with an accuracy of from ±0.1 to ±0.5 mm.

14. Device according to any one of the preceding claims, characterised in that the device (8) cooperates with a position-monitoring means in the heavy ion treatment room (4), which means monitors the tumour position in the isocentre (9).

15. Device according to claim 17, characterised in that the position-monitoring means is an X-ray camera.

16. Device according to any one of the preceding claims, characterised in that the device (8) has a computer that recalculates, as desired, the target coordinates and treatment settings for positioning the patient (1) in the lying and/or seated positions.

17. Device according to any one of the preceding claims, characterised in that the target coordinates for the irradiation of a tumour in the head/neck region are adjustable by the translational movements and subsequent isocentric rotation and/or isocentric tilting.

18. Device according to any one of the preceding claims, characterised in that camera heads of the PET camera are rotatably mounted about the heavy ion beam axis (6) for monitoring the irradiation of the patient.

19. Device according to any one of the preceding claims, characterised in that the device (8) in conjunction with a patient couch renders possible a combined irradiation of a patient in the seated and lying positions.

20. Device according to any one of the preceding claims, characterised in that the device (8) has a height-adjusting means for matching the device (8) to the body size of the patient (1) in relation to the isocentre (9) of the heavy ion beam (6).

21. Device according to claim 20, characterised in that the height-adjusting means has a travel range of from ±100 to ±500 mm, preferably from ±200 to ±300 mm.

22. Device according to claim 20 or claim 21, characterised in that the height-adjusting means has a travel speed of from 1 to 15 mm/s, preferably from 2 to 5 mm/s.

23. Device according to any one of the preceding claims, characterised in that, in a patient treatment position, the device (8) has, in the horizontal translational displacements in the X and Y directions, a travel range of from ±100 to ±200 mm, preferably from ±120 to ±150 mm.

24. Method according to claim 26, characterised in that the travel speed of the device (8) in the X and Y directions is from 5 to 20 mm/s, preferably from 8 to 10 mm\s.

25. Device according to any one of the preceding claims, characterised in that, for rotation about a horizontal axis (10), the device (8) has a tilting movement means for a tilting range of ±30°, preferably ±20°.

26. Device according to claim 28, characterised in that the speed of the tilting movement (B) is from 0.5 to 1°/s, preferably from 0.6 to 0.8°/s.

27. Device according to any one of the preceding claims, characterised in that, for rotation about a vertical axis (11), the device (8) has a rotation range of from 0 to 360°.

28. Device according to claim 30, characterised in that the speed of rotation about the vertical axis (11) is from 1 to 10°/s, preferably from 3 to 6°/s.

29. A method of treating a tumour (2) of a patient (1) in a head and/or neck region (3) in a heavy ion treatment room (5) having a heavy ion beam direction (C) that is fixed with respect to the spatial coordinates, which method, using the device (8) for positioning a tumour patient (1) according to one of the preceding claims, comprises the following steps:
calculation of an optimum bombardment angle for the heavy ion beam (5) through healthy tissue in the direction of the tumour (2);
movement of the patient chair (21) from a park position into a treatment position;
setting of the stereotactic target-point coordinates by three translations in the X, Y and Z directions so that the tumour (2) is positioned in the isocentre (9);
setting of the optimum bombardment angle by rotational movements in the isocentre (9) about a horizontal and/or a vertical axis (10,11);
measured irradiation of the tumour tissue (2), with minimal involvement of the surrounding tissue, at the calculated optimum bombardment angle.
